(19) United States
(12) Patent Application Publication
(10) Pub. No.: US 2020/0394912 A1
(43) Pub. Date: Dec. 17, 2020

(54) PARKING MODULE FOR PROCESSING PARKING DATA

(71) Applicants: TARAS KUZIN, ORANGE CITY, IA (US); STEVE ROESNER, ORANGE CITY, IA (US)

(72) Inventors: TARAS KUZIN, ORANGE CITY, IA (US); STEVE ROESNER, ORANGE CITY, IA (US)

(21) Appl. No.: 16/437,221

(22) Filed: Jun. 11, 2019

(51) Int. Cl. G08G 1/14; G06Q 10/02; G06K 9/00

(52) U.S. Cl. CPC G08G 1/143; G06Q 2240/00; G06K 9/00812; G06Q 10/02

(57) ABSTRACT

A computer implemented method allows users to identify and reserve parking using crowdsourced information. The computer implemented method processes large amounts of data related to parking; encourages peer to peer communication; and incentivizes, monetarily, the reporting of available parking. The computer implemented method is compatible with phones, web browsers, and navigation systems in cars. A software application provides a user interface which facilitates carrying out the computer implemented method.

### FIELD OF THE INVENTION

The present invention relates generally to a parking module and corresponding method for processing parking data. The parking module and method are usable in at least the transportation (both personal and commercial), automobile, parking, and towing industries. More particularly, but not exclusively, the present invention relates to a software application which utilizes crowdsourced information to facilitate the transaction of peer-to-peer parking services.

### BACKGROUND OF THE INVENTION

The background description provided herein is for the purpose of generally presenting the context of the present disclosure. Work of the presently named inventors, to the extent the work is described in the present disclosure, as well as aspects of the description that may not otherwise qualify as prior art at the time of filing, are neither expressly nor impliedly admitted as prior art.

Transportation remains a formidable problem in many urban environments. Public transportation, while often convenient, is often limited in scope and operation periods, with many starting points and destinations inadequately served. Bicycles can be used for transportation, but bicycles are inconvenient in hot, cold, or wet weather, difficult traffic conditions on roads with inadequate shoulders, or where the user wants to arrive in formal clothes. As a consequence, although their use often results in substantial traffic delays, the automobile remains the most popular form of transportation in many urban and suburban environments.

Beyond traffic delays, there are other disadvantages with the popularity of the automobiles as a medium of transportation. Notable among these disadvantages is where to park the automobile at or near the destination of interest. Parking at many popular destinations is often difficult or impossible to find, particularly at events which draw large numbers of people at designated times (e.g. sporting events, concerts, etc.). In many cases, the duration of searching for a parking spot should be taken into account in order to arrive to a destination on time. In most cases, a driver may be clueless as to where a parking spot may be available, how should he arrive to an available parking spot, the duration of parking queue and, for example, how much the parking will cost.

There exist systems and methods for assessing parking space occupancy, detecting time of parking, estimating the duration of parking queue, and for reserving parking spots, see e.g., U.S. Pat. Nos. 7,312,722 and 7,936,284. However, these systems and methods are deficient because they do not efficiently update the availability of a vast number of parking spaces. Instead, they often rely on parking vendors to update the same. Additionally, these systems and methods fail to incentivize the ability to find or facilitate parking in unconventional places (i.e., not in designated street parking, parking ramps, or parking lots).

Thus, there exists a need in the art for a software application or method which allows users to report or offer parking spots that they own or occupy and to accept or reserve available parking spots reported or offered by other users.

### SUMMARY OF THE INVENTION

Therefore, it is a primary object, feature, or advantage of the present invention to improve on or overcome the deficiencies in the art.

It is still yet a further object, feature, or advantage of the present invention to provide a software application or method that processes and filters large amounts of parking data.

It is still yet a further object, feature, or advantage of the present invention to provide a means for storing parking data and a means to access stored parking data.

It is still yet a further object, feature, or advantage of the present invention to update parking data based on crowdsourced information.

It is still yet a further object, feature, or advantage of the present invention to encourage peer to peer communication among users.

It is still yet a further object, feature, or advantage of the present invention to provide a software application, payment module, and/or method that incentivizes users to report or offer parking spots that they own or occupy by compensating them with money or credits.

It is still yet a further object, feature, or advantage of the present invention to provide a software application or method that saves users time looking for available parking.

It is still yet a further object, feature, or advantage of the present invention to provide a software application or method that allows users to easily pay for available parking.

It is still yet a further object, feature, or advantage of the present invention to provide a software application or method that may be used in a wide variety of applications.

It is still yet a further object, feature, or advantage of the present invention to provide a software application or method that improves the safety of users.

It is still yet a further object, feature, or advantage of the present invention to provide a software application or method that is cost effective.

It is still yet a further object, feature, or advantage of the present invention to provide a software application or method that is reliable and durable and has a long usable life.

It is still yet a further object, feature, or advantage of the present invention to provide a software application or method which is easily and intuitively used and reused.

It is still yet a further object, feature, or advantage of the present invention to provide a software application or method us that is easily installed and updated.

It is still yet a further object, feature, or advantage of the present invention to provide a software application or method that includes a graphical user interface which is aesthetically pleasing.

It is still yet a further object, feature, or advantage of the present invention to incorporate software application or method into a system accomplishing some or all of the previously stated objectives.

The previous list of objects, features, or advantages of the present invention are not exhaustive and do not limit the overall disclosure. Likewise, the following list of aspects or embodiments do not limit the overall disclosure. It is contemplated that any of the objects, features, advantages, aspects, or embodiments disclosed herein can be integrated with one another, either in full or in part, as would be understood from reading the present disclosure.

According to some aspects of the present disclosure, a computer implemented method comprises crowdsourcing, with at least a first non-transitory computer readable medium, an availability of one or more parking spots; updating parking data stored in a database with the availability of the one or more parking spots, said database connected to a network; receiving, from a second non-transitory computer readable medium, a search query for available parking for a user, the search query comprising a destination geographical location; identifying, with the second non-transitory computer readable medium, the availability of one or more parking spots in the destination geographical location; and communicating to the user at least one aspect of the parking data associated with the destination geographical location.

According to some additional aspects of the present disclosure, the availability of the one or more parking spots is selected from the group consisting of available, available soon, available in approximately x minutes wherein x comprises a numerical value, reserved, and not available.

According to some additional aspects of the present disclosure, the at least one aspect of the parking data is selected from the group consisting of the availability of at least one of the one or more parking spots, a location or a size of an available parking spot, a fee for parking in the available parking spot, a number of available parking spots, a range of time in which the available parking spot is available, a probability the user will be able to park in the available parking spot at an estimated time of arrival, and an estimated duration of searching time required for the user to find available parking upon arriving at the destination geographical location.

According to some additional aspects of the present disclosure, wherein the method further comprises verifying the availability of the one or more parking spots with a sensor.

According to some additional aspects of the present disclosure, the search query includes a number of parking spots.

According to some additional aspects of the present disclosure, the parking data associates: (a) an hourly rate charged by a parking meter or a parking ramp, (b) a private or public classification, (c) a physical length or area, and/or (d) an image; with the one or more parking spots.

According to some additional aspects of the present disclosure, the method further comprises filtering the parking data.

According to some additional aspects of the present disclosure, the method further comprises displaying, with a display in connection with the second non-transitory computer readable medium, on a map a location of each available parking spot at the destination geographical location.

According to some additional aspects of the present disclosure, the search query includes an estimated time of arrival.

According to some additional aspects of the present disclosure, the estimated time of arrival is based, at least partially, on a calendar associated with the user.

According to some additional aspects of the present disclosure, the method further comprises determining, with the second non-transitory computer readable medium, a probability the user will be able to park in each of the one or more parking spots at the estimated time of arrival.

According to some additional aspects of the present disclosure, the method further comprises calculating, with the second non-transitory computer readable medium, an estimated duration of searching time required for the user to find an available parking spot upon arriving at the destination geographical location.

According to some additional aspects of the present disclosure, the method further comprises suggesting, with the second non-transitory computer readable medium, the user to revise the search query if no parking spots are available at the destination geographical location.

According to some additional aspects of the present disclosure, the method further comprises reserving a selected parking spot for the user to park in.

According to some additional aspects of the present disclosure, the method further comprises issuing a voucher for the selected parking spot to be presented by the user upon arriving at the destination geographical location.

According to some additional aspects of the present disclosure, the method further comprises notifying the user if the selected parking spot is taken before the user arrives at the destination geographical location.

According to some additional aspects of the present disclosure, the method further comprises restricting access to a parking spot until the user arrives at the destination geographical location.

According to some additional aspects of the present disclosure, (a) a reporter crowdsourcing the availability of the one or more parking spots or (b) a third party holds the available parking spot until the user arrives at the destination geographical location.

According to some additional aspects of the present disclosure, the method further comprises displaying, with a display in connection with the first non-transitory computer readable medium, a make, a model, a color, and/or a license plate number of the car driven by the user.

According to some additional aspects of the present disclosure, the method further comprises displaying, with a display in connection with the second non-transitory computer readable medium, a make, a model, a color, and/or a license plate number of the car most recently parked in the selected parking spot.

According to some additional aspects of the present disclosure, the method further comprises determining a current geographical location of the user with a global positioning system (GPS) receiver.

According to some additional aspects of the present disclosure, the second non-transitory computer readable medium comprises the GPS receiver.

According to some additional aspects of the present disclosure, a car of the user comprises the GPS receiver.

According to some additional aspects of the present disclosure, the method further comprises tracking the current geographical location of the user with the GPS receiver in real time.

According to some additional aspects of the present disclosure, the method further comprises automatically calculating, with the second non-transitory computer readable medium, an estimated time of arrival based on the current geographical location of the user and the destination geographical location.

According to some additional aspects of the present disclosure, automatically calculating, with the second non-transitory computer readable medium, the estimated time of arrival is additionally based on traffic data.

According to some additional aspects of the present disclosure, the method further comprises prompting the user whether the user would like the second non-transitory computer readable medium to identify available parking.

According to some additional aspects of the present disclosure, a virtual assistant prompts the user. The virtual assistant forms part of an operating system of the second non-transitory computer readable medium, comprises a natural-language user interface, and uses voice queries to ask and answer questions.

According to some additional aspects of the present disclosure, an audio notification or a visual notification prompts the user.

According to some additional aspects of the present disclosure, the method further comprises allowing the user to rate or review another user.

According to some additional aspects of the present disclosure, the method further comprises allowing the user to view information related to a user specific account, said information including (a) at least some bibliographic information related to a person or a car; (b) financial data (e.g., funds or deficits) associated with the user specific account; or (c) a reliability rating.

According to some additional aspects of the present disclosure, the method further comprises storing where the user parked and/or reminding the user where the user parked.

According to some other aspects of the present disclosure, a computer implemented method comprises crowdsourcing, with at least a first non-transitory computer readable medium, an availability of one or more parking spots; receiving, with a second non-transitory computer readable medium, the availability of the one or more parking spots; and confirming, with the second non-transitory computer readable medium, whether the one or more parking spots are to be reserved for a user.

According to some additional aspects of the present disclosure, the method further comprises making a recommendation to the user to park in the one or more parking spots.

According to some additional aspects of the present disclosure, the recommendation is based, at least in part, on a factor selected from the group consisting of (a) a phone number, (b) a license plate number, (c) an email address, and (d) a geographic location of the user.

According to some other aspects of the present disclosure, a non-transitory computer readable medium comprises a communications module capable of connecting to a network, a parking module, and a payment module. The parking module is capable of reporting an availability of one or more parking spots; submitting a search query for available parking, the search query comprising a destination geographical location and/or an estimated time of arrival; receiving, from a database connected to the network, parking data which includes the availability of the one or more parking spots; selecting or reserve a parking spot to park in; and cancelling the execution of at least one other function. The payment module is capable of adding funds to a user specific account, making a payment, and viewing received payments or credits sent to the user specific account.

According to some additional aspects of the present disclosure, receiving, from a database connected to the network, parking data which includes the availability of the one or more parking spots is executed in real time whenever the communications module is connected to the network.

According to some additional aspects of the present disclosure, the non-transitory computer readable medium further comprises a map module which projects graphic representations of parking spaces, based at least in part on availability, on a virtual map.

According to some additional aspects of the present disclosure, the payment module is capable of advertising and/or soliciting.

According to some additional aspects of the present disclosure, a user interface allows a user to provide an input which instructs the parking module, the map module, the payment module, and/or the communications module to perform a function.

According to some additional aspects of the present disclosure, the parking module is capable of communicating where the user parked.

According to some additional aspects of the present disclosure, the parking module is capable of rating or reviewing another user, wherein a rating or a review submitted by the user will be at least partially used to establish a reliability rating of the another user.

According to some additional aspects of the present disclosure, the parking module is capable of allowing the user to view information related to the user's personal user specific account, said information including (a) at least some bibliographic information related to the user or a car associated with the user, (b) financial data (e.g., funds or deficits) associated with the user specific account, and (c) a reliability rating of the user.

According to some additional aspects of the present disclosure, the parking module is capable of allowing the user to view information related to a user specific account associated with another user, said information including (a) at least some bibliographic information related to the another user or a car associated with the another user and (b) a reliability rating of the another user.

According to some additional aspects of the present disclosure, the parking module is capable of restricting functionality unless the user signs into a user specific account with appropriate permissions.

According to some additional aspects of the present disclosure, restricting comprises not allowing the user to customize an aesthetic look of a graphical user interface associated with the user interface or preventing the parking module from performing at least one function.

According to some additional aspects of the present disclosure, the payment module requires user authentication before adding funds to the user specific account, making the payment, or viewing the received payment or the received credit.

According to some other aspects of the present disclosure, a car comprising the non-transitory computer readable medium according to any one of the aforementioned aspects of the present disclosure.

According to some additional aspects of the present disclosure, the car further comprises a global positioning system (GPS) receiver for determining a current geographical location of the user, said GPS receiver capable of communicating with the non-transitory computer readable medium.

According to some additional aspects of the present disclosure, the car is a self-driving car.

According to some other aspects of the present disclosure, a computer implemented method comprises allowing a reporter to crowdsource, with a first non-transitory computer readable medium, an availability of one or more parking spots in a destination geographical location; identifying, with a second non-transitory computer readable medium, one of the one or more parking spots in the destination geographical location is an available parking spot; and automatically paying the reporter a payment or a credit if the user parks in the available parking spot.

According to some additional aspects of the present disclosure, the method further comprises updating parking data stored in a database with the availability of the one or more parking spots, said database connected to a network and receiving, with a second non-transitory computer readable medium, a search query for available parking for a user, the search query comprising the destination geographical location.

According to some additional aspects of the present disclosure, the method further comprises automatically paying a parking meter, a parking ramp, or a third party for parking in the available parking spot.

According to some additional aspects of the present disclosure, the reporter selects whether to be paid with the payment or the credit.

According to some additional aspects of the present disclosure, the method further comprises storing the payment or the credit in an account assigned to the reporter.

According to some additional aspects of the present disclosure, the user pays the reporter for crowdsourcing the availability of the one or more parking spots.

According to some additional aspects of the present disclosure, the user pays a third party if the user parks in one of the one or more parking spots and the third party pays the reporter for crowdsourcing the availability of the one or more parking spots.

According to some additional aspects of the present disclosure, the user advances payment to the third party and the third party deducts a fixed fee or a percentage of the advance payment to pay the reporter.

According to some additional aspects of the present disclosure, the advance payment is a lump sum payment.

According to some additional aspects of the present disclosure, the advance payment is a recurring payment.

According to some additional aspects of the present disclosure, an advertiser pays the reporter for crowdsourcing the availability of the one or more parking spots.

According to some additional aspects of the present disclosure, the third party retains a portion of the payment.

According to some additional aspects of the present disclosure, the third party maintains the database.

According to some additional aspects of the present disclosure, the third party manages and/or operates land and/or a valet parking service comprising the destination geographical location.

According to some additional aspects of the present disclosure, the value of the payment or the credit is based in part on the destination geographical location.

According to some additional aspects of the present disclosure, the value of the payment or the credit is based in part on an estimated time of arrival.

According to some additional aspects of the present disclosure, the value of the payment or the credit is based in part on the number of available parking spots.

According to some additional aspects of the present disclosure, the value of the payment or the credit is based in part on the number of users seeking parking spots.

According to some additional aspects of the present disclosure, the method further comprises soliciting, with the second non-transitory computer readable medium, a price for an available parking spot near the destination geographical location.

According to some additional aspects of the present disclosure, the method further comprises accepting, with the first non-transitory computer readable medium, the price.

According to some additional aspects of the present disclosure, the method further comprises holding or restricting access to the available parking space until the user arrives at the destination geographical location.

According to some additional aspects of the present disclosure, the method further comprises discounting an amount of the payment or the credit if (a) the user enters a promotional code, (b) the user has a particular membership classification, (c) the user pays directly from the user specific account, and/or (d) the user bundles the payment or the credit to the reporter with other payments or credits.

These or other objects, features, and advantages of the present invention will be apparent to those skilled in the art after reviewing the following detailed description of the illustrated embodiments, accompanied by the attached drawings.

### BRIEF DESCRIPTION OF THE DRAWINGS

FIG. 1 shows a diagram illustrating a system for processing parking data based on crowdsourced information, according to some aspects of the present disclosure.

FIG. 2 shows a diagram illustrating an exemplary hardware environment for practicing the present invention, according to some aspects of the present disclosure.

FIG. 3 shows a diagram illustrating exemplary elements of a search query, according to some aspects of the present disclosure.

FIG. 4 shows a diagram illustrating exemplary functions of a parking module, according to some aspects of the present disclosure.

FIG. 5 shows a diagram illustrating exemplary functions of a map module, according to some aspects of the present disclosure.

FIG. 6 shows a diagram illustrating exemplary functions of a payment module, according to some aspects of the present disclosure.

FIG. 7 shows a diagram illustrating exemplary functions of a communications module, according to some aspects of the present disclosure.

FIG. 8 shows a diagram illustrating exemplary steps of a database driven computer implemented method for parking, according to some aspects of the present disclosure.

FIG. 9 shows a diagram illustrating exemplary steps of a peer-to-peer computer implemented method for parking, according to some aspects of the present disclosure.

FIG. 10 shows a diagram illustrating exemplary steps of a computer implemented method for facilitating payment related to parking, according to some aspects of the present disclosure.

Various embodiments of the present disclosure illustrate several ways in which the present invention may be practiced. These embodiments will be described in detail with reference to the drawings, wherein like reference numerals represent like parts throughout the several views. Reference to specific embodiments does not limit the scope of the present disclosure and the drawings represented herein are presented for exemplary purposes.

### DETAILED DESCRIPTION OF THE INVENTION

### Definitions—Introductory Matters

The following definitions and introductory matters are provided to facilitate an understanding of the present invention. Unless defined otherwise, all technical and scientific terms used herein have the same meaning as commonly understood by one of ordinary skill in the art to which embodiments of the present invention pertain.

The terms “a,” “an,” and “the” include plural referents unless context clearly indicates otherwise. Similarly, the word “or” is synonymous with “and/or” and is intended to include “and” unless context clearly indicate otherwise. The word “or” means any one member of a particular list and also includes any combination of members of that list.

The terms “invention” or “present invention” as used herein are not intended to refer to any single embodiment of the particular invention but encompass all possible embodiments as described in the specification and the claims.

The term “about” as used herein refers to variation in the numerical quantities that can occur, for example, through typical measuring techniques and equipment, with respect to any quantifiable variable, including, but not limited to, mass, volume, time, distance, angle, wave length, frequency, voltage, current, and electromagnetic field. Furthermore, there is certain inadvertent error and variation that is likely through differences in the manufacture, source, or purity of the components used to make or carry out the present invention. The claims include equivalents to the quantities whether or not modified by the term “about.”

The term “configured” describes an apparatus, system, or other structure that is constructed to perform or capable of performing a particular task or to adopt a particular configuration. The term “configured” can be used interchangeably with other similar phrases such as constructed, arranged, adapted, manufactured, and the like. The term “user” as used herein is a person who is at some point in need of parking, regardless of whether the user is aware the user needs parking, the user is actively seeking parking, the user has already parked, or the like. If the user is actively seeking parking, the term “user” can be interchanged with the word “requester.” However, it is to be appreciated that the “requester” may not actually drive or own the car which is to be parked.

The term “reporter” as used herein is a person(s) capable of crowdsourcing information related to parking. It is to be appreciated there is nothing in the present disclosure which suggests a person or group of persons cannot function as both a “reporter” and a “user.” On the contrary, the devices, modules, and software applications discussed in the present disclosure typically provide means for both reporting and seeking available parking.

In communications and computing, a computer readable medium is a medium capable of storing data in a format readable by a mechanical device. The term “non-transitory” is used herein to refer to computer readable media (CRM) that store data for short periods or in the presence of power such as a memory device or random-access memory (RAM).

Terms such as first, second, vertical, horizontal, top, bottom, upper, lower, front, rear, end, sides, concave, convex, and the like, are referenced according to the views presented. These terms are used only for purposes of description and are not limiting unless these terms are expressly included in the claims. Orientation of an object or a combination of objects may change without departing from the scope of the invention.

Numerical adjectives and adverbs (e.g., first, second, etc.), positional adjectives and adverbs (e.g., vertical, horizontal, forward, aft, etc.), nouns referencing a portion of or orientation of an object (e.g., top, bottom, sides, etc.), and the like are referenced according to the views presented. These terms are used only for purposes of description and are not limiting unless these terms are expressly included in the claims. The physical configuration of an object or a combination of objects may change without departing from the scope of the present invention.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

The apparatuses, systems, and methods of the present invention may comprise, consist essentially of, or consist of the components of the present invention described herein. The term “consisting essentially of” means that the apparatuses, systems, and methods may include additional components or steps, but only if the additional components or steps do not materially alter the basic and novel characteristics of the claimed apparatuses, systems, and methods.

### Overview

The following embodiments are described in sufficient detail to enable those skilled in the art to practice the invention however other embodiments may be utilized. Mechanical, procedural, and other changes may be made without departing from the spirit and scope of the invention. Accordingly, the scope of the invention is defined only by the appended claims, along with the full scope of equivalents to which such claims are entitled.

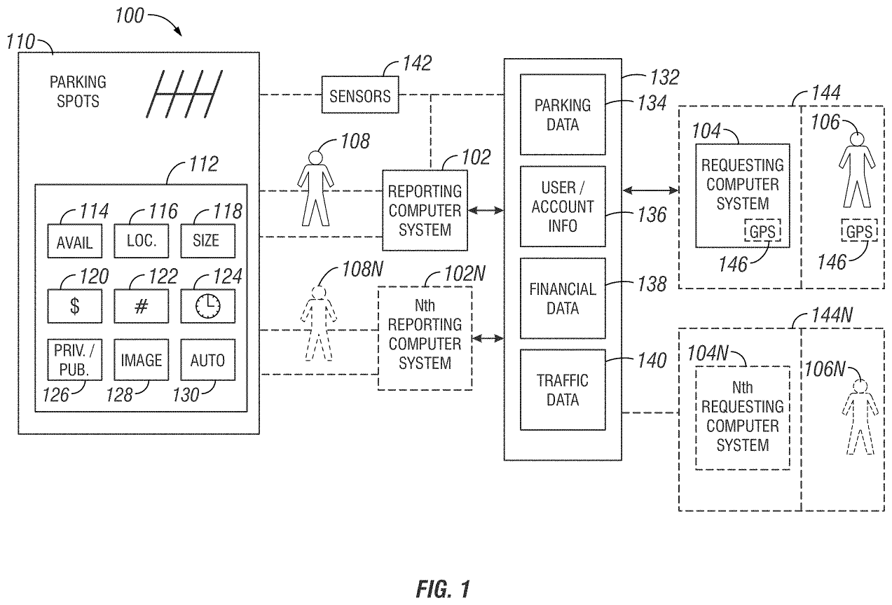

FIG. 1 shows a parking information and reservation system 100 which comprises a number of non-transitory computer readable media to crowdsource parking data and retrieve information related to the same.

The parking information and reservation system 100 comprises at least one reporting non-transitory computer readable medium 102 and at least one requesting non-transitory computer readable medium 104. However, any number of other reporting non-transitory computer readable media 102N and any number of other requesting non-transitory computer readable medium 104N may be used simultaneously in connection with the present invention. The requesting non-transitory computer readable medium 104 allows a user 106 and other user(s) 106N to seek available parking in part based on crowdsourced information obtained from a reporter 108 and other reporters(s) 108N through use of at least one reporting non-transitory computer readable medium 102.

The reporting non-transitory computer readable medium 102 is primarily responsible for crowdsourcing information related to parking spot(s) 110. More particularly, the reporting non-transitory computer readable medium 102 reports an aspect 112 of the parking spot(s) 110 or parking data. For example, the aspect 102 can include an availability 114, a location 116, a size 118, a fee 120, a number 122 of parking spots, a time range 124, a private or public classification 126, an image 128, automobile information 130, or the like.

The availability 114 of the parking spot 110 is selected from the group consisting of available, available soon, available in approximately x minutes, wherein x comprises a numerical value, reserved, and not available. The availability 114 of the parking spot 110 can also include whether the parking spot 110 is handicap accessible. The availability 114 of a parking spot 110 can even include reason(s) as to why parking is unavailable. For example, the reasons could include the parking spot 110 is currently occupied, the parking spot 110 is not available because construction prohibits entry, parking is illegal at the present time of day, etc.

The location 116 of the parking spot 110 can include varying levels of specificity. For example, the location 116 could comprise a street address, longitude and latitude coordinates, text describing the location of the parking spot, a marker on a map of an area of land comprising the parking spot, etc. The location 116 can also include information as to whether the parking spot 110 is located outdoors or indoors; proximately to an entrance of a building, an elevator, or an event; what floor the parking spot 110 is located on; if it is necessary to pass through a security gate to access the parking spot 110; etc.

The size 118 of the parking spot 110 can include physical length; physical width; area; clearance height; whether the spot is designated for or permits motorcycles, compact cars, trailers, or semis to park in the parking spot 110; etc.

The fee 120 can comprise an hourly rate for a parking meter or a parking ramp associated with the parking spot 110; an entry, event, or flat fee; whether the fee 120 associated with the parking spot 110 is negotiable; etc.

The number 122 of parking spots can comprise a total number of parking spots, a number of available parking spots, an estimated number of available parking spots, a percentage of available parking spots divided by the total number of parking spots, or the like.

The time range 124 typically begins with a time when parking is first permitted and concludes with a time in which parking is first prohibited. Several time ranges may comprise the time range 124. For example, these time ranges can vary based on the day of the week or whether a holiday is being observed. The time range 124 can also comprise text, such as parking permitted 24 hours a day, parking not permitted at this time, or the like. The time range 124 can also be combined with the availability 114 such that an estimated range of time in which a space will be available is provided, i.e., “this parking spot is expected to be available from 3:00 p.m. to 4:30 p.m.”

The private or public classification 126 typically comprises just that, a determination of whether the parking spot 110 is private or public. However, the present disclosure also contemplates that certain information, such as whether the parking spot is available for lease, sale, etc., may be included with a private classification.

The image 128 associated with the parking spot 110 can include varying levels of specificity. For example, the image 128 can comprise a diagram, schematic, or “blueprint” of a parking lot or parking ramp. Alternatively, the image 128 can comprise a photograph or a video (perhaps even updated in real time) of the actual parking spot 110. To provide less specificity, a street view of the address the parking spot 110 is associated with can be provided. Similarly, a photo of a representative parking spot may be provided, rather than a photo of the actual parking spot 110.

The automobile information 130 can comprise a make, a model, a color, and/or a license plate number of any car formerly, or preferably most recently, parked in the parking spot 110. This may help the user 106 identify the parking spot 110 more easily if the parking spot 110 is being reserved for the user 106.

The reporting non-transitory computer readable medium 102 reports the aspect 112 of the parking spot(s) 110 to a database 132 where the aspect 112 is stored with other parking data 134, user and account information 136, financial data 138, and traffic data 140. The database 132 is updated accordingly.

The database 132 is a structured set of data typically held in a computer. The database 132 is preferably one that is accessible in various ways. The database 132, as well as data and information contained therein, need not reside in a single physical or electronic location. For example, the database 132 may reside, at least in part, on a local storage device, in an external hard drive, on a database server connected to a network, on a cloud-based storage system, in a distributed ledger (such as those commonly used with blockchain technology), or the like.

In some embodiments, verification or filtering of the parking data 134, user and account information 136, financial data 138, and/or traffic data 140 is used to maintain accuracy of the same. For example, a sensor 142 or multiple sensors can be employed to verify whether an aspect 112 provided by a reporter 108 is accurate.

More particularly, the sensors 142 sense one or more characteristics of an object and can include cameras (and other vision-type sensors), accelerometers, position sensors, or pressure sensors (including weight sensors), among many others. The accelerometers can sense acceleration of an object in a variety of directions (e.g., an x-direction, a y-direction, etc.). The position sensors can sense the position of one or more components of an object. For example, the position sensors can sense the position of an object relative to another fixed object such as a wall. Pressure sensors can sense the pressure of a gas or a liquid or even the weight of an object.

Fewer or more sensors 142 can be provided as desired. For example, a fluid level sensor can sense a measurement of fluid contained in a container or the depth of a fluid in its natural form such as water in a river or a lake, a rotational sensor can be used to detect speed(s) of object(s), a photodetector can be used to detect light or other electromagnetic radiation, a motion or distance sensor can be used to detect the distance an object has traveled, a timer can be used for detecting a length of time an object has been used and/or the length of time any component has been used, and a temperature sensor can be used to detect the temperature of an object or fluid.

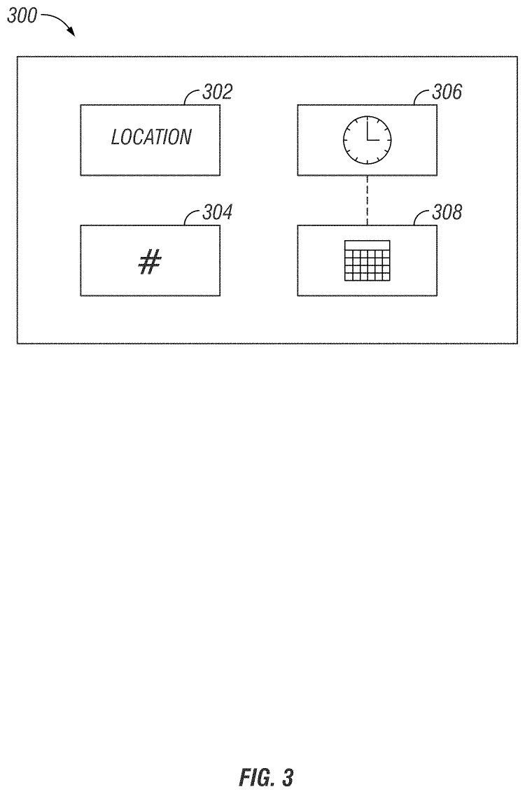

The requesting non-transitory computer readable medium 104 is capable of submitting a search query 300, the search query 300 including a destination geographical location 302 (discussed in more detail with reference to FIG. 3), for available parking for the user 106. In any event, the requesting non-transitory computer readable medium 104 will aim to identify an available parking spot based on the availability 114 of the parking spot(s) 110 in the destination geographical location 302 and, at least in a preferred embodiment, will communicate to the user 106 the same. Based on the communicated information, the user 106 will then be able to park a car 144 in the identified parking spot 110.

In some embodiments, a satellite-based radio-navigation system such as the global positioning system (“GPS”) is used. GPS is owned by the United States and uses satellites to provide geolocation information to a GPS receiver 146. GPS, and other satellite-based radio-navigation systems, can be used for location positioning, navigation, tracking, and mapping in real time. The requesting non-transitory computer readable medium 104 or the user's car 144 typically comprises the GPS receiver 146, however embodiments which employ an external GPS tracking device including the GPS 146 are contemplated.

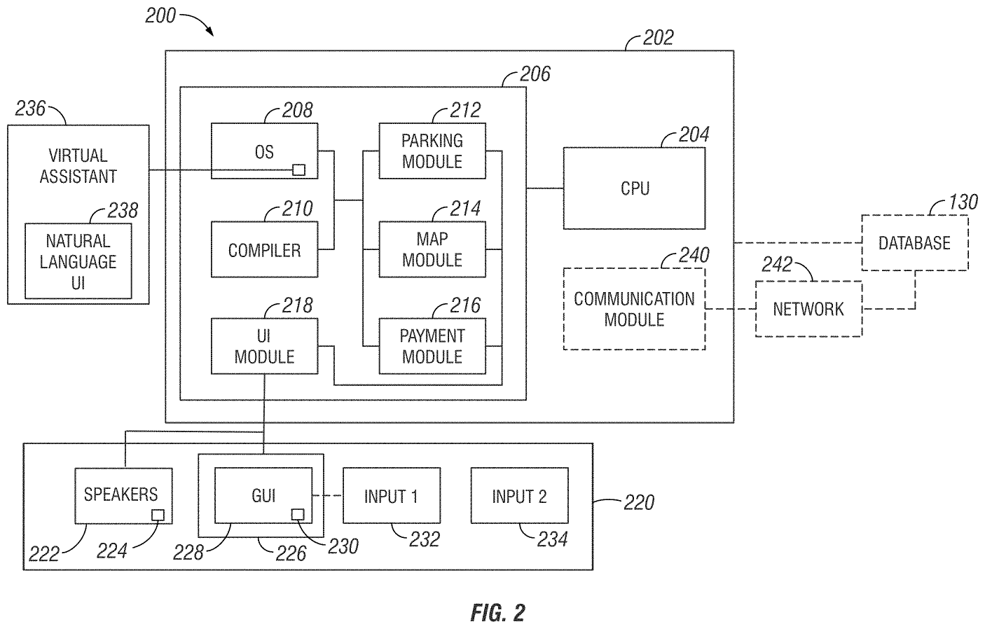

FIG. 2 shows an exemplary computer system 200 that could be used to implement selected elements of the present invention, including a non-transitory computer readable medium 202 and a user interface (“UI”) 220. The non-transitory computer readable medium 202 shown and described with reference to FIG. 2 may function as both the reporting non-transitory computer readable medium 102 and the requesting non-transitory computer readable medium 104 of FIG. 1.

Referring back to FIG. 2, the non-transitory computer readable medium 202 according to the aspects of the present disclosure may also include components such as an intelligent control and communication components. Examples of such intelligent control units may be in the central processing unit 204 alone or in tablets, telephones, handheld devices, laptops, user displays, or generally any other computing device capable of allowing input, providing options, and showing output of electronic functions. Still further examples include a microprocessor, a microcontroller, or another suitable programmable device and a memory. The controller also can include other components and can be implemented partially or entirely on a semiconductor (e.g., a field-programmable gate array (“FPGA”)) chip, such as a chip developed through a register transfer level (“RTL”) design process.

The memory 206 includes, in some embodiments, a program storage area and a data storage area. The program storage area and the data storage area can include combinations of different types of memory, such as read-only memory (“ROM”, an example of non-volatile memory, meaning it does not lose data when it is not connected to a power source) or random access memory (“RAM”, an example of volatile memory, meaning it will lose its data when not connected to a power source). Some additional examples of volatile memory include static RAM (“SRAM”), dynamic RAM (“DRAM”), synchronous DRAM (“SDRAM”), etc. Additional examples of non-volatile memory include electrically erasable programmable read only memory (“EEPROM”), flash memory, a hard disk, an SD card, etc. In some embodiments, the central processing unit 204, such as a processor, a microprocessor, a microcontroller, or an arithmetic logic unit (“ALU”) is connected to the memory 206 and executes software instructions that are capable of being stored in a RAM of the memory (e.g., during execution), a ROM of the memory (e.g., on a generally permanent basis), or another non-transitory computer readable medium such as another memory or a disc.

Generally, the non-transitory computer readable medium 202 operates under control of an operating system 208 stored in the memory 206. The non-transitory computer readable medium 202 also implements a compiler 210 which allows a software application written in a programming language such as COBOL, C++, FORTRAN, or any other known programming language to be translated into code readable by the central processing unit 204. After completion, the software application accesses and manipulates data stored in the memory 206 of the non-transitory computer readable medium 202 using the relationships and logic that was generated using the compiler 210.

In one embodiment, instructions implementing the operating system 208, a software application, and the compiler 210 are tangibly embodied in the computer-readable medium 202, which could include one or more fixed or removable data storage devices, such as a zip drive, floppy disc drive, hard drive, CD-ROM drive, tape drive, etc. Furthermore, the operating system 208 and the software application are comprised of instructions which, when read and executed by the non-transitory computer readable medium 202, causes the non-transitory computer readable medium 202 to perform the steps necessary to implement and/or use the present invention. A software application and/or operating instructions may also be tangibly embodied in memory 206 and/or data communications devices, thereby making the software application a product or article of manufacture according to the present invention.

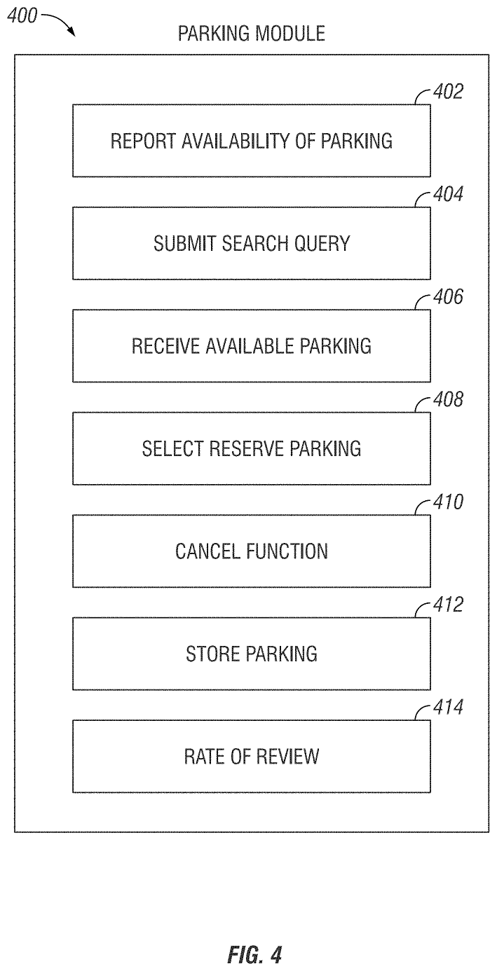

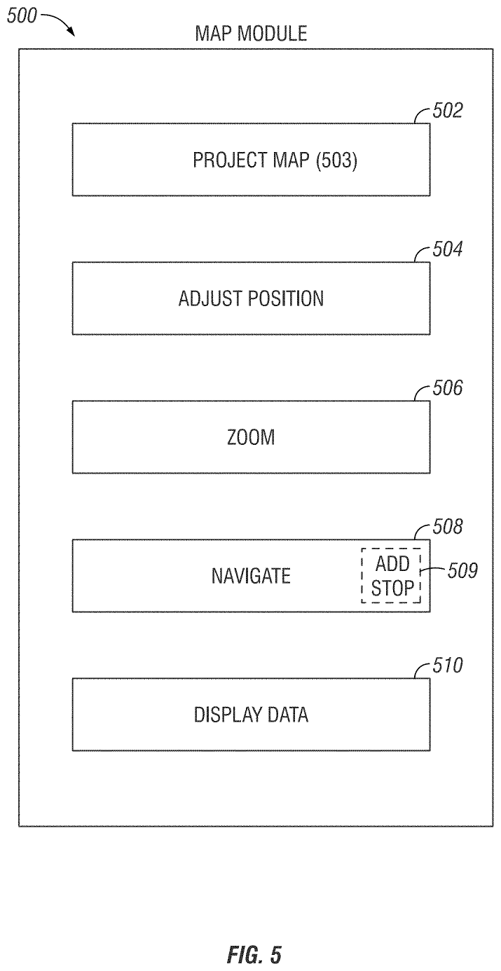

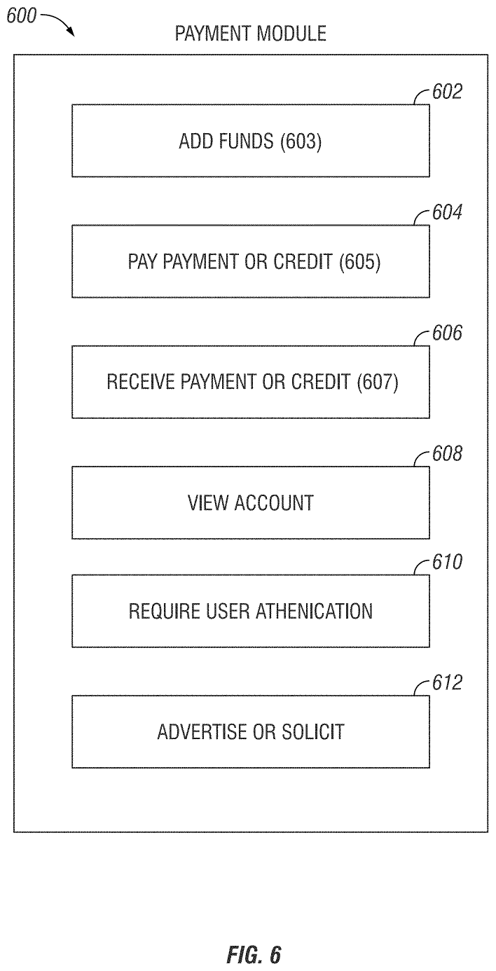

In a preferred embodiment, the program storage area and/or data storage areas comprise a parking module 212 (discussed in more detail with reference to FIG. 4), a map module 214 (discussed in more detail with reference to FIG. 5), a payment module 216 (discussed in more detail with reference to FIG. 6), and a user-interface module 218. The non-transitory computer readable medium 202 interfaces with the user 106 to accept inputs 232, 234 and commands through at least part of the user interface 220 and to present results through the user interface module 218. Although the user interface module 218 is depicted as a separate module, the instructions performing the user interface functions can be resident or distributed in the operating system 208, another software application, or module. Alternatively, the instructions can be implemented with special purpose memory and processors.

The user interface 220 is how the user interacts with the non-transitory computer readable medium 202. The user interface 220 could be a digital interface, a command-line interface, a graphical user interface (“GUI”), or any other way a user can interact with a machine. For example, in a preferred embodiment, the user interface 220 comprises speakers 222, a display 224, and one or more means for receiving inputs 232, 234 from the user 106. The speakers 222 can transmit audio, such as an audio notification 224, in response to instructions received from the operating system 208, the parking module 212, the map module 214, the payment module 216, and/or the user interface module 218. Non-limiting examples of the audio notification 224 include a chime, music, a voice message, an alert, or the like.

The display 224 typically comprises an electronic screen which projects a graphical user interface 228 to the user 106. More particularly, the display could be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The graphical user interface 228 may employ visual notifications 230 in response to instructions received from the operating system 208, the parking module 212, the map module 214, the payment module 216, and/or the user interface module 218. Non-limiting examples of the visual notification 230 include an icon, image, a video message, an alert, or the like.

The means for receiving inputs 232, 234 can comprise a combination of digital and analog input and/or output devices or any other type of user interface input/output device required to achieve a desired level of control and monitoring for a device. Examples of input and/or output devices include computer mice, keyboards, touchscreens, knobs, dials, switches, buttons, etc. Input(s) 232, 234 received from the user interface 220 can then be sent to a microcontroller to control operational aspects of a device.

In some embodiments, the operating system 208, user interface module 218, and/or user interface 220 can be included with a virtual assistant 236 which comprises a natural-language user interface 238. The virtual assistant 236 is capable of using voice queries to ask and answer questions, thereby allowing allows for a voice of the user 106 to act as an input 232, 234 to the computer system 200. The virtual assistant's ability to speak to the user 106 may help facilitate giving directions, prompt the user to give more specific information and/or instructions to the computer system 200, and reduce the time it takes to provide more complicated inputs 232, 234.

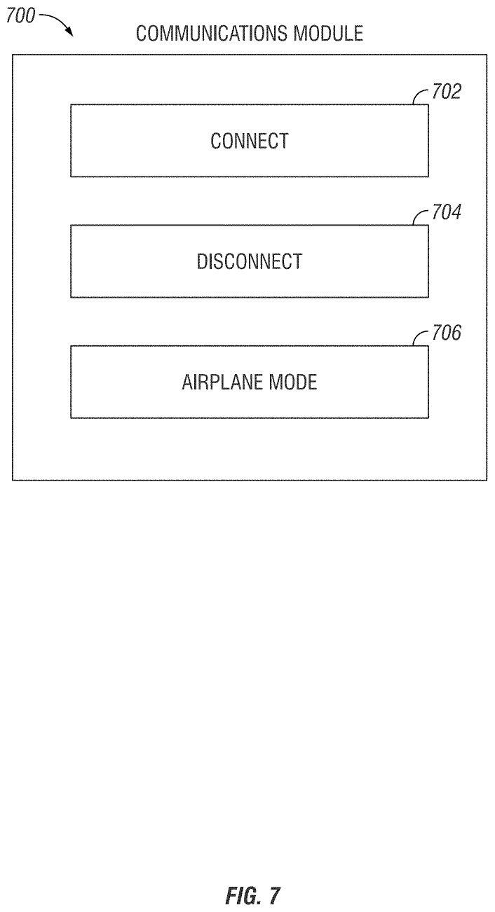

Also included in the non-transitory computer readable medium 202 is a communications module 240 (discussed in more detail with reference to FIG. 7) for connecting to the Internet and/or a network 242 also connected to the database 132.

In some embodiments, the network 242 is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communications protocols, such as Wi-Fi, Bluetooth, ZigBee, near field communication (“NFC”), etc., although other types of networks are possible and are contemplated herein. The network 242 typically allows communication between the communications module 240 and the central location during moments of low-quality connections. Communications through the network 242 can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like. In some embodiments, the non-transitory computer readable medium 202 can include one or more communications ports such as Ethernet, serial advanced technology attachment (“SATA”), universal serial bus (“USB”), or integrated drive electronics (“IDE”), for transferring, receiving, or storing data.

The non-transitory computer readable medium 202 is typically powered by a power supply. The power supply outputs a particular voltage to a device or component or components of a device. The power supply could be a DC power supply (e.g., a battery), an AC power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (LSD-NiMH) battery, a nickel-cadmium battery (NiCd), a lithium-ion battery, or a lithium-ion polymer (LiPo) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

As shown in FIG. 3, a basic search query 300 comprises a destination geographical location 302, a requested number of parking spots 304 (e.g., parking may be requested for more than one car), and an estimated time of arrival 306. The search query 300 will imply the requested number of parking spots 304 is one if not specified. The estimated time of arrival 306 can be manually input, calculated automatically based on a current geographical location sensed by the GPS receiver 146 and other traffic data 140, or determined after a user's calendar 308 is integrated with the search query 300. More complicated search queries 300 will comprise additional elements relating to other aspects 112 of a parking space 110.

As shown in FIG. 4, the parking module 212 is capable of performing parking module functions 400. For example, the parking module 212 can provide the ability to report 402 any aspect 112 of one or more parking spots 110. The parking module 212 can provide the ability to submit 404 a search query 300 for available parking. The parking module 212 can provide the ability to receive 406, from the database 132, parking data 134 which includes the aspect 112 of the one or more parking spots 110. The parking module 212 can provide the ability to select or reserve 408 a parking spot 110 to park in. The parking module 212 can provide the ability to cancel 410 the execution of other functions 400. The parking module 212 can provide the ability to store 412 where the user 106 parked. The parking module 212 can provide the ability to rate or review 414 other users 106N.

As shown in FIG. 5, the map module 214 is capable of performing map module functions 500. The map module 214 can provide the ability to project 502 a map 503 onto a display, such as the display 226. The map module 214 can provide the ability to adjust 504 a position on the map 503. For example, the user 106 can move the view of a map 503 in a northward direction, an eastward direction, a southward direction, a westward direction, or any combination thereof. Even the destination geographic location 302 of a search query 300 can be adjusted using the adjustment function 504. The map module 214 can provide the ability to zoom 506 in an effort to provide a view which provides more detail (“zooming in”) or a view which encompasses a larger territory (“zooming out”). By combining the adjust function 504 and the zoom function 506 together, a user 106 can quickly view details of locations which are a large distance from one another. The map module 214 can provide the ability to navigate 508 from one geographic location to the next. For example, the navigate function 508 can engage the natural language user interface 238 of the virtual assistant 236 which forms part of the operating system 208 to verbally give directions to the user 106. Alternatively, a list of directions can be provided to the user 106. The user 509 can use the navigate function 508 to add stops 509 along a path of travel. The map module 214 can provide the ability to display data, such as weather data or information and data stored on the database 132, perhaps in connection with the map 503 or directions provided to the user.

As shown in FIG. 6, the payment module 216 is capable of performing payment module functions 600. The payment module 216 can provide the ability to add 602 funds to a user specific account 603. The payment module 216 can provide the ability to make 604 a payment 605. The payment module 216 can provide the ability to view 608 a received payment or a received credit 607. The payment module 216 can provide the ability to. The payment module 216 can provide the ability to require user authentication 611 before adding funds 602 to a user specific account 603, making 604 a payment 605, or viewing 608 the received payment or the received credit 607.

User authentication 611 comprises the ways in which someone may be authenticate. The user authentication 611 is typically based on three types of factors: something the user knows, something the user has, and something the user is. Each authentication factor covers a range of elements used to authenticate or verify a person's identity prior to being granted access, approving a transaction request, providing a signature, granting authority to others, and establishing a chain of authority. Typical knowledges factors comprise a password, a partial password, a pass phrase, a personal identification number (PIN), a challenge response (the user 106 must answer a question or a pattern), or a security question. Typical ownership factors comprise a built-in hardware token, a software token, or a hardware device holding a software token. Typical inherence factors comprise a fingerprint, a retinal pattern, a signature, face, a voice, a unique bio-electric signals, or another biometric identifier.

In the event user authentication 611 is used at all, only a single component from one of the aforementioned factors needs to be used to authenticate an individual's identity. However, some forms of user authentication 611 will require multi-factor authentication. Multi-factor authentication typically involves two or more authentication factors (something you know, something you have, or something you are). Two-factor authentication is a special case of multi-factor authentication involving exactly two factors.

Finally the payment module 216 can provide the ability to advertise or solicit 612 ads to user(s) and reporter(s), usually in exchange for the advertiser paying at least one party, a fee for showing an ad.

As shown in FIG. 7, the communications module 240 is capable of performing communications module functions 700. Namely the communications module 240 can provide the ability to connect 702 or disconnect 704 to the network 242. Additionally, the communications module 240 can provide the ability to allow the non-transitory computer readable medium to engage airplane mode 706, which may or may not disable a GPS receiver 146 associated therewith.

### Operation

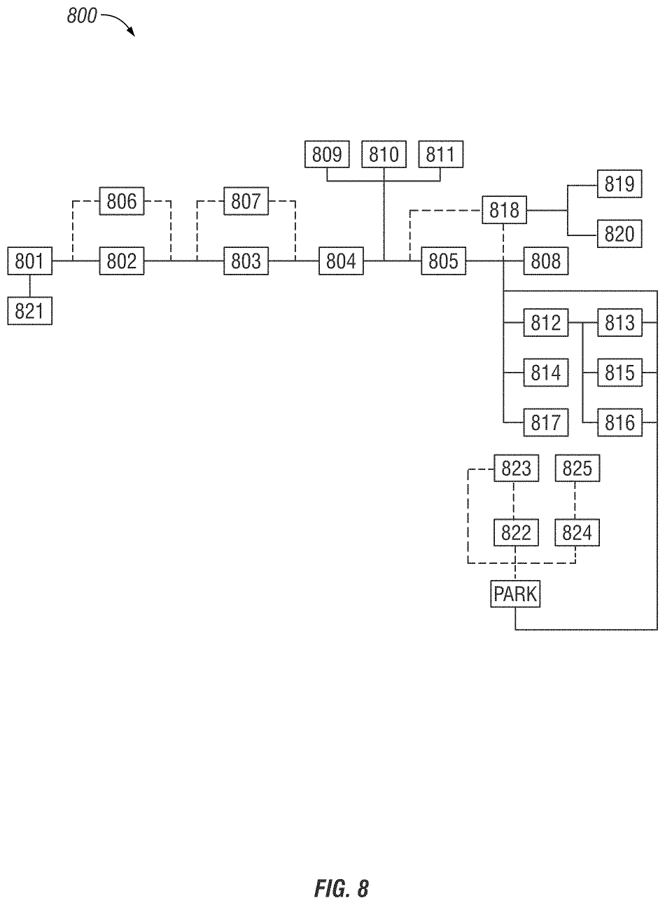

FIGS. 8-10 provide process flow charts suggesting an order of operation for steps performed in exemplary embodiments of the present invention. The suggested order of the steps is not intended to limit the claims of the present disclosure unless the claims specify as much. It will be appreciated that the steps of any one embodiment in FIGS. 8-10 may be substituted for, subtracted from, or added to any of the embodiments shown in FIGS. 8-10. To perform the steps discussed hereafter, hardware and software elements such as those provided in the aforementioned figures may be utilized, however the present disclosure is not to be limited to the use of these elements unless the claims specify as much. For example, while it will be understood that the “first non-transitory computer readable medium” can be the reporting non-transitory computer readable medium 102 however the “first non-transitory computer readable medium” can also be any other unspecified non-transitory computer readable medium having the structural features specified in the claims or those that are necessary to performed any claimed function(s) or step(s).

In a first example, FIG. 8 illustrates a database driven computer implemented method 800 for parking. In the embodiment shown, a first non-transitory computer readable medium crowdsources 801 an availability of one or more parking spots. Thereafter, a database connected to a network and storing parking data will be updated 802 with the availability of the one or more parking spots. Thereafter, a search query comprising a destination geographical location will be received 803 from a second non-transitory computer readable medium. Thereafter, the second non-transitory computer readable medium will identify 804 the availability of the one or more parking spots in the destination geographical location. Thereafter, at least one aspect of the parking data associated with the destination geographical location will be communicated 805 to the user.

Optionally, the availability of the one or more parking spots can be verified 806 with a sensor, prior to the updating step 802 or prior to the receiving step 803.

Optionally, the parking data may be filtered 807 prior to the receiving step 803 or the identifying step 804.

Optionally, after the communicating step 805, a display, in connection with the second non-transitory computer readable medium, can display 808 on a map a location of each available parking spot at the destination geographical location or display 817 a make, a model, a color, and/or a license plate number of the car most recently parked in the selected parking spot.

Optionally, prior to or simultaneous with the communicating step 805, the second non-transitory computer readable medium can determine 809 a probability the user will be able to park in each of the one or more parking spots at the estimated time of arrival, calculate 810 an estimated duration of searching time required for the user to find an available parking spot upon arriving at the destination geographical location, or suggest 811 the user to revise the search query if no parking spots are available at the destination geographical location.

Optionally, after the communicating step 805, a selected parking spot can be reserved 812 for the user to park in. Thereafter, a voucher may be issued 813 for the selected parking spot to be presented by the user upon arriving at the destination geographical location, access to a parking spot may be restricted 815 until the user arrives at the destination geographical location, and/or a display, in connection with the first non-transitory computer readable medium, displays 116 a make, a model, a color, and/or a license plate number of the car driven by the user. If the selected parking spot is taken before the user arrives at the destination geographical location, the user can be notified 814 of such. If no such notification 814 happens, the user typically parks thereafter. After parking, the user can rate or review 822 another user or a reporter, wherein a rating or a review submitted by the user will be at least partially used to establish a reliability rating of the other user or reporter; the user can store 824 where the user parked; and/or the user can be reminded 825 of where the user parked. Users and reporters alike can view 823 information related to their own user specific account such as (a) at least some bibliographic information related to their person or their car, (b) financial data (138) associated with their user specific account (603); and (c) their reliability rating. Users and reporters alike can view 823 information related to others' user specific accounts such as (a) at least some bibliographic information related to a person or the person's car and (b) the person's reliability rating.

Optionally, either prior to or just after the communicating step 805, a current geographical location of the user can be determined 818 with a global positioning system (GPS) receiver. The position of the user may then be tracked 819 and an estimated time of arrival can be calculated by the second non-transitory computer readable medium. This estimation can be updated in real time as the user moves closer to or farther away from the destination location.

Prior to each and every aforementioned step, the second non-transitory computer readable medium can prompt 821 the user whether the user would like the second non-transitory computer readable medium to identify available parking. For example, this could occur if the second non-transitory computer readable medium is near a popular destination or if the user decides to use a navigation application in their phone and not the parking related software application. The prompting 821 can be accomplished by a virtual assistant forming part of an operating system of the second non-transitory computer readable medium. The virtual assistant can even comprise a natural-language user interface and use voice queries to ask and answer questions. Alternatively, an audio notification or a visual notification can prompt 821 the user.

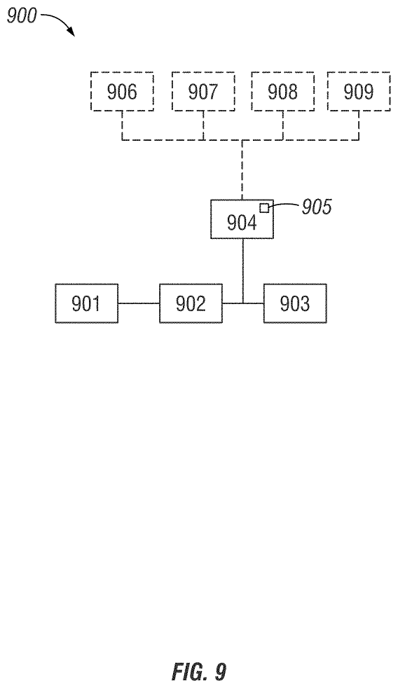

In another example, FIG. 9 illustrates a peer-to-peer computer implemented method 900 for parking. In the embodiment shown, a first non-transitory computer readable medium crowdsources 901 an availability of one or more parking spots. Thereafter, a second non-transitory computer readable medium directly receives 902 an aspect of parking data, including the availability of the one or more parking spots from the first non-transitory computer readable medium. Thereafter, the second non-transitory computer readable medium confirms 903 whether the one or more parking spots are to be reserved for a user. Such a confirmation 903 can be established by a simple yes or no answer from the user regarding whether the using would like to reserve parking. The confirmation 903 can even comprise making a reservation for a specific parking spot.

Optionally, to aid the user in selecting a parking spot, the second non-transitory computer readable medium can recommend 904 the user park in a specific parking spot. In making the recommendation 904, the second non-transitory computer readable medium can consider several factors 905. For example, a factor may be selected from the group consisting of a phone number 906, a license plate number 907, an email address 908, or a geographical location 909 (e.g. current geographic location, mailing address, a business address, etc.

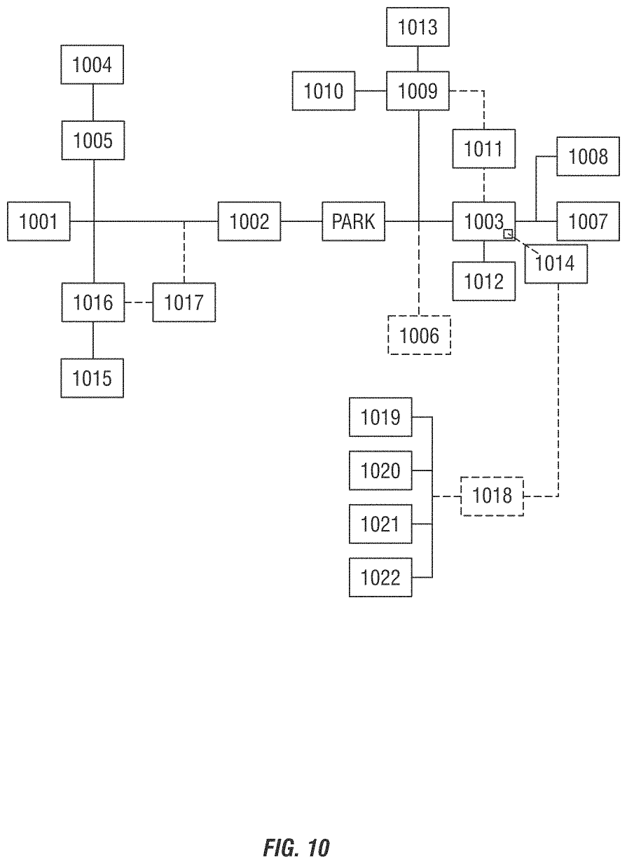

In another example, FIG. 10 illustrates a computer implemented method 1000 for facilitating payment related to parking. In the embodiment shown, a reporter crowdsources 1001 with a first non-transitory computer readable medium an availability of one or more parking spots in a destination geographical location. Thereafter, a second non-transitory computer readable medium identifies 1002 one of the one or more parking spots in the destination geographical location is an available parking spot. Thereafter, the reporter is automatically payed 1003 a payment or a credit if the user parks in the available parking spot.

Optionally, a database storing parking data and connected to a network can be updated 1004 with the availability of the one or more parking spots after the crowdsourcing step 1001. Thereafter, but prior to the identifying step 1002, a search query can be received 1005 from a second non-transitory computer readable medium for available parking for a user, the search query comprising the destination geographical location.

Optionally, after the user parks, and regardless of when the reporter is paid, the user may have to pay 1006 a parking meter, a parking ramp, or a third party for parking in the available parking spot.

Optionally, after payments are made, the reporter can select 1007 whether to be paid with a payment or a credit. The payment or credit can be stored 1008 in an account assigned to the reporter.

Optionally, a third party 1009 can pay the reporter if the user parks in one of the one or more parking spots identified as available by the reporter. For example, the user could advance 1010 payment to the third party 1009 and a fixed fee or a percentage of the payment could be thereafter deducted 1011 from the advance payment 1010 to pay 1003 the reporter. The advance payment 1010 could be a lump sum payment or a recurring payment. The third party 1009 could perhaps retain a portion of the payment, maintain the database, or manage and/or operate 1013 land and/or a valet parking service comprising the destination geographical location.

Optionally, an could advertise 1012 and pay, either directly or indirectly, the reporter for crowdsourcing 1001 the availability of the one or more parking spots.

Optionally, the value or price 1014 of the payment or the credit can be based in part on the destination geographical location, an estimated time of arrival, the number of available parking spots, the number of users seeking parking spots, or the like.

Optionally, the value or price 1014 for an available parking spot near the destination geographical location could be solicited 1015 by a user and/or the second non-transitory computer readable medium prior to the identifying step 1002. Thereafter, a reporter and/or the first non-transitory computer readable medium could accept 1016 the value or price 1014 or could seek to further negotiate the same. In the event the reporter accepts the parking spot, the reporter could hold or restrict 1017 access to the available parking space until the user arrives at the destination geographical location.

Optionally, the value or price 1014 for an available parking spot could be discounted 1018 if the user enters a promotional code 1019, has a particular membership classification 1020, pays directly from the user specific account 1021, and/or bundles 1022 the payment or the credit to the reporter with other payments or credits.

From the foregoing, it can be seen that the present invention accomplishes at least all of the stated objectives.

### LIST OF REFERENCE NUMREALS

The following list of reference numerals is provided to facilitate an understanding and examination of the present disclosure and is not exhaustive. Provided it is possible to do so, elements identified by a numeral may be replaced or used in combination with any elements identified by a separate numeral. Additionally, numerals are not limited to the descriptors provided herein and include equivalent structures and other objects possessing the same function.
100 parking information and reservation system
102 reporting non-transitory computer readable medium
102N additional reporting non-transitory computer readable medium(s)
104 requesting non-transitory computer readable medium
104N additional requesting non-transitory computer readable medium(s)
106 user
106N another user(s)
108 reporter
108N another reporter(s)
110 parking spot(s)
112 aspect of parking spot(s) and/or parking data
114 availability
116 location
118 size
120 fee
122 number of parking spots (availability)
124 range of time
126 private or public classification
128 image
130 recently parked car information
132 database
134 parking data
136 user/account information
138 financial data
140 traffic data
142 sensor(s)
144 user car
144N another user(s) car
146 global position system (GPS) receiver
200 computer system
202 non-transitory computer readable medium
204 computer processing unit
206 memory
208 operating system
210 compiler
212 parking module
214 map module
216 payment module
218 user interface module
220 user interface
222 speakers
224 audio notification
226 display
228 graphical user interface
230 visual notification
232 first input
234 second input
236 virtual assistant
238 natural language user interface
240 communications module
242 network
300 search query
302 destination geographical location
304 number of parking spots (requesting)
306 estimated time of arrival
308 calendar
400 parking module functions
402 report function
404 submit function
406 receive function
408 select or reserve function
410 cancel function
412 store function
414 rate or review function
500 map module functions
502 project function
503 map
504 adjust position function
506 zoom function
508 navigate function (can engage natural language user interface to give directions)
509 stop
510 (display) data function
600 payment module functions
602 add function
603 funds
604 pay function
605 payment or credit
606 receive function
607 received payment or credit
608 view function
610 require function
611 user authentication
612 advertise or solicit function
700 communications module functions
702 connect function
704 disconnect function
706 airplane mode function
800 computer implemented method
801 crowdsourcing step
802 updating step
803 receiving step
804 identifying step
805 communicating step
806 verifying step
807 filtering step
808 displaying (map) step
809 determining (probability) step
810 calculating (search time) step
811 suggesting step
812 reserving step
813 issuing step
814 notifying step
815 restricting step
816 displaying (user car information) step
817 displaying (parked car information) step
818 determining (current geographical location) step
819 tracking step
820 calculating (estimated time of arrival) step
821 prompting step
822 rating or reviewing step
823 viewing (account information) step
824 storing (parking location) step
825 reminding step
900 computer implemented method
901 crowdsourcing step
902 receiving step
903 confirming step
904 recommending step
905 factors
906 phone number
907 license plate number
908 an email address
909 geographic location (e.g. current geographic location, mailing address, etc.)
1000 computer implemented method
1001 crowdsourcing step
1002 identifying step
1003 paying step
1004 updating step
1005 receiving step
1006 additional paying step (e.g. parking meter, a parking ramp, or a third party)
1007 selecting step
1008 storing (payment) step
1009 third party involvement
1010 advancing step
1011 deducting step
1012 advertising aspect
1013 managing or operating step
1014 value or price
1015 soliciting step
1016 accepting step
1017 restricting step
1018 discounting step
1019 promotional code
1020 membership classification
1021 direct payment from a user specific account
1022 bundled payment

The present disclosure is not to be limited to the particular embodiments described herein. The following claims set forth a number of the embodiments of the present disclosure with greater particularity.

What is claimed is:

1. A computer implemented method comprising:
crowdsourcing, with at least a first non-transitory computer readable medium, an availability of one or more parking spots;
updating parking data stored in a database with the availability of the one or more parking spots, said database connected to a network;
receiving, from a second non-transitory computer readable medium, a search query for available parking for a user, the search query comprising a destination geographical location;
identifying, with the second non-transitory computer readable medium, the availability of one or more parking spots in the destination geographical location; and
communicating to the user at least one aspect of the parking data associated with the destination geographical location.

2. The computer implemented method of claim 1 wherein the availability of the one or more parking spots is selected from the group consisting of:
available;
available soon;
available in approximately x minutes, wherein x comprises a numerical value;
reserved; and
not available.

3. The computer implemented method of claim 1 wherein the at least one aspect of the parking data is selected from the group consisting of:
the availability of at least one of the one or more parking spots;
a location or a size of an available parking spot;
a fee for parking in the available parking spot;
a number of available parking spots;
a range of time in which the available parking spot is available;
a probability the user will be able to park in the available parking spot at an estimated time of arrival; and
an estimated duration of searching time required for the user to find available parking upon arriving at the destination geographical location.

4. The computer implemented method of claim 1 further comprising verifying the availability of the one or more parking spots with a sensor.

5. The computer implemented method of claim 1 wherein the parking data associates:
(a) an hourly rate charged by a parking meter or a parking ramp;
(b) a private or public classification;
(c) a physical length or area; or
(d) an image
with the one or more parking spots.

6. The computer implemented method of claim 1 further comprising filtering the parking data.

7. The computer implemented method of claim 1 wherein the search query includes an estimated time of arrival.

8. The computer implemented method of claim 6 wherein the estimated time of arrival is based, at least partially, on a calendar associated with the user.

9. The computer implemented method of claim 6 further comprising determining, with the second non-transitory computer readable medium, a probability the user will be able to park in each of the one or more parking spots at the estimated time of arrival.

10. The computer implemented method of claim 1 further comprising:
reserving a selected parking spot for the user to park in; and
(a) issuing a voucher for the selected parking spot to be presented by the user upon arriving at the destination geographical location; or
(b) notifying the user if the selected parking spot is taken before the user arrives at the destination geographical location.

11. The computer implemented method of claim 10 further comprising restricting access to a parking spot until the user arrives at the destination geographical location, wherein:
(a) a reporter crowdsourcing the availability of the one or more parking spots; or
(b) a third party holds the available parking spot until the user arrives at the destination geographical location.

12. The computer implemented method of claim 1 further comprising:
determining or tracking a current geographical location of the user with a global positioning system (GPS) receiver; and
calculating, with the second non-transitory computer readable medium, an estimated time of arrival based on the current geographical location of the user and the destination geographical location.

13. The computer implemented method of claim 1 further comprising prompting the user whether the user would like the second non-transitory computer readable medium to identify available parking, wherein:
(a) an audio notification;
(b) a visual notification; or
(c) a virtual assistant forming a part of an operating system of the second non-transitory computer readable medium, comprising a natural-language user interface, and using voice queries to ask and answer questions;
prompts the user.

14. The computer implemented method of claim 1 further comprising allowing the user to rate or review another user.

15. The computer implemented method of claim 1 further comprising allowing the user to view information related to a user specific account, said information including:
(a) at least some bibliographic information related to a person or a car;
(b) funds or deficits associated with the user specific account; or
(c) a reliability rating.

16. The computer implemented method of claim 1 further comprising storing where the user parked or reminding the user where the user parked.

17. A computer implemented method comprising:
crowdsourcing, with at least a first non-transitory computer readable medium, an availability of one or more parking spots;
receiving, with a second non-transitory computer readable medium, the availability of the one or more parking spots; and
confirming, with the second non-transitory computer readable medium, whether the one or more parking spots are to be reserved for a user.

18. The computer implemented method of claim 17 further comprising making a recommendation to the user to park in the one or more parking spots, said recommendation based, at least in part, on a factor selected from the group consisting of:
(a) a phone number;
(b) a license plate number;
(c) an email address; and
(d) a geographic location of the user.

19. A non-transitory computer readable medium comprising:
a communications module capable of connecting to a network; and
a parking module capable of:
reporting an availability of one or more parking spots;
submitting a search query for available parking, the search query comprising a destination geographical location and/or an estimated time of arrival;
receiving, from a database connected to the network, parking data which includes the availability of the one or more parking spots;
selecting or reserve a parking spot to park in; and
cancelling the execution of other functions;
a payment module capable of:
adding funds to a user specific account;
making a payment; and
viewing a received payment or a received credit.

20. The non-transitory computer readable medium of claim 19 further comprising a map module which projects graphic representations of parking spaces, based at least in part on availability, onto a display.
